(19) United States
(12) Patent Application Publication
(10) Pub. No.: US 2010/0003496 A1
(43) Pub. Date: Jan. 7, 2010

(54) ELECTRO-LUMINANT FABRIC STRUCTURES

(75) Inventors: Tilak Dias, Stockport (GB); Ravindra Marks Monaragala, Homagama (LK)

Correspondence Address: MCANDREWS HELD & MALLOY, LTD, 500 WEST MADISON STREET, SUITE 3400, CHICAGO, IL, 60661, US

(73) Assignee: THE UNIVERSITY OF MANCHESTER, Manchester (GB)

(21) Appl. No.: 12/367,345

(22) Filed: Feb. 6, 2009

Related U.S. Application Data
(63) Continuation of application No. PCT/GB2007/002942, filed on Aug. 2, 2007.

(30) Foreign Application Priority Data
Aug. 8, 2006 (GB) 0615761.4

(51) Int. Cl. D02G 3/36; B32B 5/02; D03D 15/00; D04B 1/14; D04C 1/06

(52) U.S. Cl. 428/222; 428/378; 428/372; 428/221; 442/187; 442/307; 87/8

(57) ABSTRACT

Luminant fabrics are disclosed in which an electro-luminescent material is activated by electrodes within the fabric. A yarn for use in such a fabric has a conductive core with an electro-luminescent layer coated thereon. A protective coating may be added. A plurality of such yarns may be used in contact with each other, with the respective cores connected to a source of alternating electric current. Application of the current creates an electric field which causes luminescence of the electro-luminescent layer.

### RELATED APPLICATIONS

This application is a Continuation-In-Part of International Application No. PCT/GB2007/002942, filed Aug. 2, 2007, now pending. That entire application is incorporated by reference here.

### BACKGROUND OF THE INVENTION

The invention relates to electro-luminant materials, to the creation of illuminated zones or areas at a fabric surface, and to yarns for use in such fabrics. The invention has particular, but not exclusive application to knitted fabrics.

Electro-luminant materials are known. Essentially, such a material comprises a substance which luminesces upon exposure to an electric field. Typically, the substance comprises a phosphor. DuPont has produced a range of electro-luminescent inks or pastes under the name LUXPRINT®. In these materials, phosphors are microencapsulated to protect them against moisture, with the encapsulated phosphors held in a binder to form an ink or paste. This range of materials luminesces when subject to an electric field of 60 to 120 volts AC, at frequencies in the range 50 to 1000 Hz. A preferred operating range is 80 to 120 volts AC at 400 Hz.

The DuPont materials referred to above have been used in laminar structures, sandwiched between what are effectively two sheet electrodes. One of the electrodes is in the form of a translucent conductive ink such that when the field is applied, the luminescing phosphor is visible through the translucent ink electrode.

In the DuPont material structure as referred to above, the electrical field is created perpendicular to the plane of the laminar structure; i.e., between the sheet electrodes at either surface. We have found that a layer of electroluminescent material of the kind referred to above can be caused to luminesce in an electric field created over a surface rather than one created perpendicularly across it. Described herein is a sheet product having two electrodes incorporated at spaced locations thereon to define a surface area therebetween. A layer of electro-luminescent material is disposed in this area, and conductive pathways are provided on the product for connecting the electrodes to a source of electrical power. When the power is applied, it creates an electrical field in the area, and causes the material to luminesce at the surface.

### SUMMARY OF THE INVENTION

Preferred products of the kind described above are fabrics; woven, knitted or stitch-bonded, but most preferably knitted. The electrodes can be mounted at the product surface, but where the product is a fabric the electrodes are preferably incorporated within the structure of the fabric. In such an embodiment, the electrodes may comprises yarns which themselves form components of the fabric. The connections to the electrodes can take any suitable form, but once again when the product is a fabric of some kind, conductive pathways can readily be formed in the fabric during its manufacturing process.

It will be appreciated that whatever the shape or orientation of the electrodes, in products of the invention the luminescent area created is dependent entirely upon the shape and extent of the layer of electroluminescent material in the area between the electrodes. The electroluminescent material can of course substantially fill that area, but can create different shapes within it. The electrodes can be elongate and extend along a boundary of the layer of the material. Generally, the electrodes will be linear and define a polygonal, not necessarily right angular, area therebetween.

In addition to providing means for luminescing different shapes within the area defined by the electrodes, the color and intensity of the light generated can also be varied by using different luminescent materials, and different densities thereof within the electroluminescent material layer. Normally the electro-luminescent material will be of the kind described above from DuPont, but the present invention also contemplates phosphor particles being held either individually or in groups within the fabric. Phosphor particles may be encapsulated within the yarns of a fabric or within the filaments of multifilament yarns within a fabric, using the technique described in our International Patent Application No: GB06/001804.

The layer of electro-luminescent material may be a separate component in fabric according to the invention. It can, though, itself comprise individual yarns. Such a yarn according to the invention comprises a conductive core having a layer of electroluminescent material coated thereon. The layer of electro-luminescent material is normally applied as an ink of the kind referred to above. The ink can be secured in place by baking, for example by exposure to Ultra-Violet (UV) light for a short period immediately after application. The exposure time will depend primarily on the diameter of the yarns which could be mono-filament or multi-filament yarns and the intensity of UV applied. A further protective layer can be applied over the electro-luminescent layer, itself baked on by exposure to UV light. Coated yarns of this type can be activated to luminesce by application of a high AC voltage between two yarns in contact with each other. Different color effects may be created by the color of the luminescence alone or in combination with a color element in a protective layer over the electro-luminescent layer.

The present invention is concerned particularly with luminescent yarns of the kind described above used in combination. In an embodiment of the invention each of a plurality of yarns has an electrically conductive core with a layer of electro-luminescent material coated thereover. The yarns are in contact with one another along their length, and provided with means for connecting the yarn cores to a source of alternating electric current. Connection of the yarn cores to such an AC supply generates an electric field between the cores and provokes luminescence of the luminescent material. Yarns of this kind, with only the electro-luminescent material and possibly a protective layer therefor, on the conductive core, have sufficient flexibility to be useful in a range of fabrics, and particularly in knitted or embroidered fabrics.

The plurality of yarns may be knitted, woven, braided or embroidered into a fabric in such a manner to be in the requisite contact. They may follow a common path in contact with one another in a fabric made up in other respects of different yarns, to define a potentially luminescent path or pattern. They can also be combined to form a twisted thread of for example, two or three yarns.

In a knitted structure coated yarns of the kind just described can be brought into contact with one another according to a predetermined plan. This means a variety of different luminescent designs can be created. Different color or illumination effects can also be created by connecting yarns to different electrical circuitry.

Fabric structures comprising a plurality of engaging yarns as described above can be used in combination with a conductive layer or backing also connected to the AC supply. This creates a luminescent surface by virtue of different voltages being applied to the backing and to individual yarn cores. The fabric structure may be knitted, woven, braided or embroidered. The conductive layer or backing can be metallic.

Electro-luminescent yarns in which a conductive core is coated with an electroluminescent material can also be used in seams and embroidered fabrics. In a standard chain stitch an electro-luminescent yarn can be the needle thread in combination with a plain conductive yarn as the looper thread. By applying an AC voltage to both threads an electric field is created at the contact points, causing the coating material to luminesce. By altering the tensions in the two threads the contact points can be moved toward or away from the fabric surface. This technique can also be used to embroider electro-luminescent yarns on a fabric to create luminescent areas or patterns.

There are numerous applications for the present invention but a particular one is in garments. Where individuals have to work in dark conditions, and cannot rely on reflected light to identify them, products or fabrics embodying the invention can be effectively applied to their clothing. Other applications would include floor, wall or ceiling coverings where lighted areas are required either for direct illumination such as in an automobile roof lining, a point identification on a wall such as a light switch in a darkened area, and identifying walkways or aisles in airplanes or theaters. In such applications a back surface, either behind or part of the fabric itself, can be reflective.

### BRIEF DESCRIPTION OF SEVERAL VIEWS OF THE DRAWINGS

The invention will now be described by way of example and with reference to the accompanying schematic drawings, wherein:

FIG. 1 shows a plan view of a portion of a first sheet product with electro-luminescent regions created therein;

FIG. 2 is a sectional view taken on line A-A of FIG. 1;

FIG. 3 is a plan view of a portion of a second sheet product with electro-luminescent regions created therein;

FIG. 4 is a plan view similar to that of FIG. 3 of a portion of a third sheet product with electro-luminescent regions created therein;

FIG. 5 is a plan view similar to that of FIG. 3 of a portion of a fourth sheet product with electro-luminescent regions created therein;

FIG. 6 shows the elements of a yarn for use in the fabric shown in FIG. 5;

FIG. 7 is a cross-section through the yarn of FIG. 6;

FIG. 8 illustrates the coating and curing steps for applying the various layers to the core of the yarn of FIGS. 6 and 7;

FIG. 9 is an electric circuit illustrating the luminescing process;

FIG. 10 is a longitudinal cross-section through the yarn of FIGS. 6 and 7;

FIG. 11 shows a system for activating a yarn of the kind shown in FIGS. 6 and 7;

FIG. 12 illustrates a twist thread consisting of a plurality of yarns;

FIG. 13 shows a section of woven fabric including multiple yarns; and

FIG. 14 shows a section of knitted fabric using twisted yarn in adjacent courses.

### DESCRIPTION OF PREFERRED EMBODIMENTS

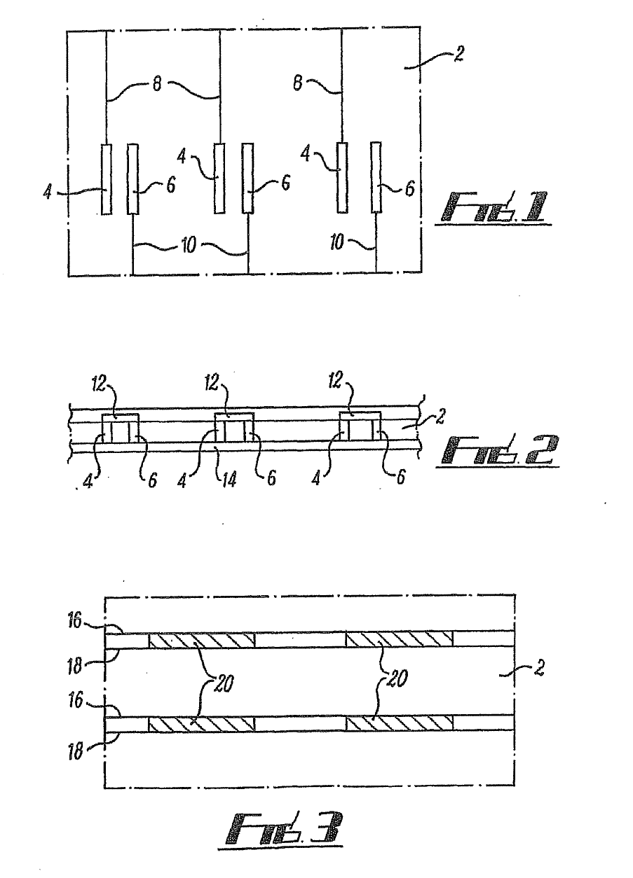

FIG. 1 shows the surface of a sheet product 2 according to the invention. Elongate electrodes 4 and 6 are arranged in pairs on the surface, with electrodes 4 being connected along pathways 8, and electrodes 6 along pathways 10, to a source of electrical power (not shown).

Between each pair of electrodes on the surface of the product is applied an electro-luminescent material 12, such as a DuPont LUXPRINT® ink of the kind referred to above. Where required, a protective layer can be applied over the luminescent material.

The spacing of the electrodes in sheet products of the invention will be determined in relation to the frequency of the voltage required to energize the electroluminescent material. Higher voltages and higher frequencies will generally be required for greater electrode spacing, but this requirement may be mitigated by installing an insulator between the electrodes, or ensuring appropriate insulative characteristics of the base sheet product. As noted above, the invention can be particularly effectively applied to fabrics, and even more particularly to knitted fabrics. In a knitted fabric, the electrodes 4,6 as shown in FIGS. 1 and 2, and the conductive pathways 8, can be created by knitting courses and/or wales using conductive yarns. Suitable such yarns are made from multiple fine silver filaments. With such a fabric structure, it is preferred also to apply an insulative layer to the surface of the fabric opposite that upon which the luminescent material is applied, as well as over the luminescent material itself.

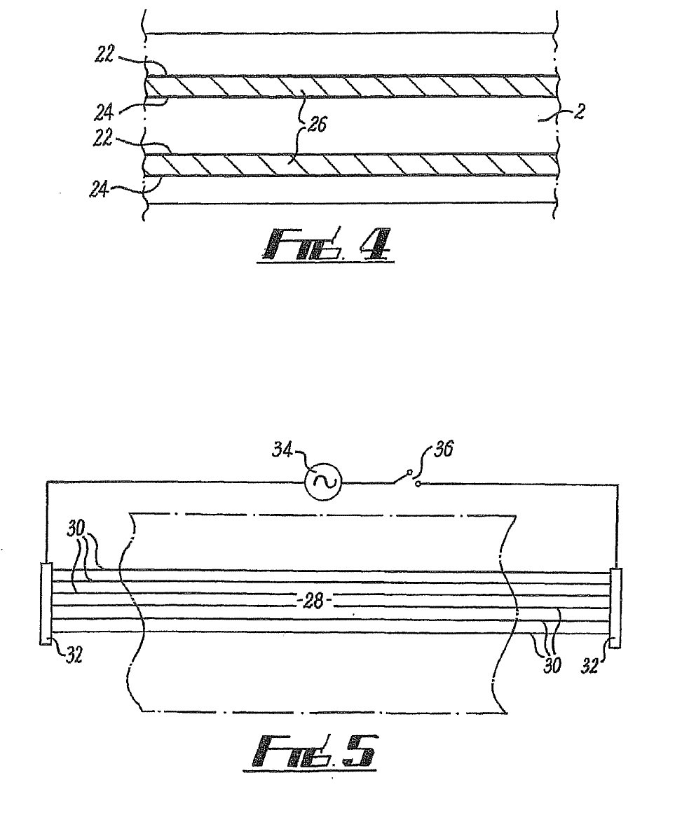

In the fabric of FIG. 3, electrodes 16 and 18 are effectively created by continuous adjacent silver courses. The electro-luminescent zones 20 are created by phosphor particles encapsulated within the fibers of a textile yarn using the technique described in our International Patent Application No: GB06/001804, referred to above, and incorporated here by reference. In the knitted fabric illustrated, lengths of this specialist yarn can be incorporated in the respective zones without difficulty. The use of Jacquard knitting techniques and a positive yarn delivery system of the kind disclosed in published Patent Specification No: GB06/001804 facilitates precise positioning of the electro-luminescent zones 20, in accordance with a predetermined pattern. Where the electroluminescent material is an ink of the kind referred to above, the pigment will normally be introduced into the binder.

FIG. 4 illustrates a variation on the fabric of FIG. 3. In this embodiment, also using a knitted fabric, electro-luminescent particles are microencapsulated within individual polymeric yarns, either monofilament or multifilament yarns. These yarns are knitted between adjacent courses of conductive (silver) yarns 22,24 to form luminescent areas 26. The ratio of the number of electro-luminescent courses to the number of silver courses will influence the voltage and frequency required in the electric field between the courses to energize the respective electro-luminescent zones.

In the fabric of FIG. 5 an electro-luminescent zone 28 is created by yarns 30 each comprising a conductive core with a coating thereon of electroluminescent material of the kind referred to above. The yarns extend between terminals 32 connected to a source 34 of alternating current through a circuit completed by a switch 36. When the switch is closed, the AC creates electric fields between adjacent, preferably touching yarns which cause them to luminesce.

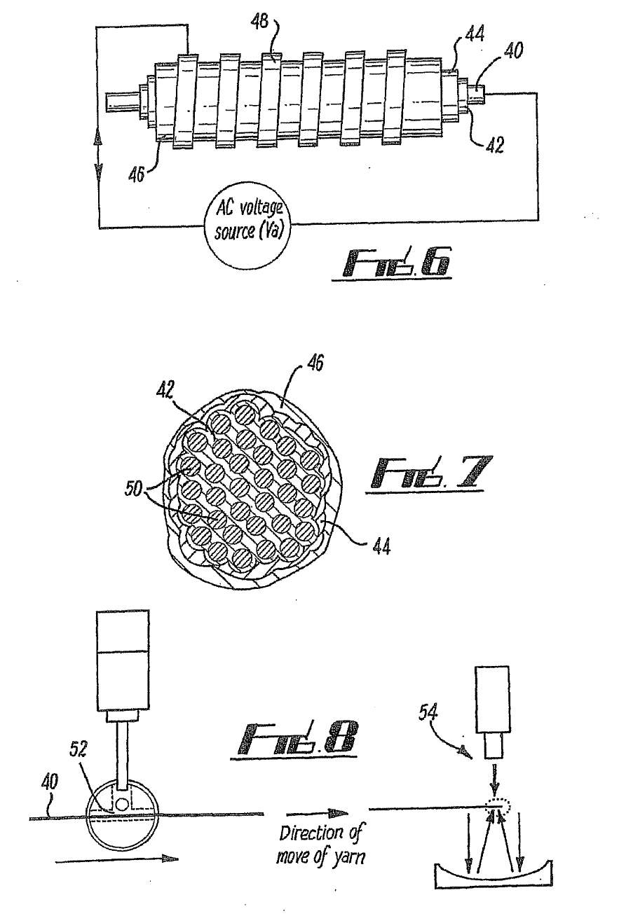

FIG. 6 illustrates the construction of an electro-luminescent yarn suitable for use in the fabric of FIG. 5. The conductive core 40 is coated in a first insulation layer 42, to which is applied an electro-luminescent layer 44. This is enclosed in a second insulation layer 46, around which is wound a conductive strip or wire 48. An additional protective coating can be applied over the wire or strip 48, but the need for this will depend upon the eventual deployment of the yarn.

A cross-section of the yarn of FIG. 6 is shown in FIG. 7. The conductive core is a silver-coated multifilament nylon yarn, such as is available under the trademark SHIELDEX from Swicofil AG Textile Services. The first insulation layer 42 is a dielectric screen printing paste available from E.I. DuPont de Nemours and Company. The paste fills the voids between the individual filaments 50, such that the multifilament yarn behaves very much as a monofilament for coating with the electro-luminescent layer 44. The electroluminescent layer comprises electro-luminescent phosphor, and suitable materials are phosphor inks produced by DuPont, and can be adapted to luminesce in different colors.

The second insulation layer 46 is an encapsulant available from Dymax Corporation. The conductive wire or strip (not shown in FIG. 7) typically consists of copper, and is wound around the yarn in a helical formation. Although shown with closely spaced loops, in practice the winding will be much more relaxed, at an angle of around 30° to the yarn axis.

The insulation and luminescent layers are applied to the core 40 using conventional techniques. Thus, the first insulation layer 42 is applied by passing the core 40 through a bath 52 of the insulation material, and the coated yarn then cured using ultra-violet light 54. The process is then repeated for the electro-luminescent (44) and second insulation (46) layers before the conductive wire or strip is finally wound round the completed yarn. The coating and curing steps are illustrated in FIG. 8.

A particular example of a yarn of the kind illustrated in FIG. 7, the uncoated core 40 has a weight of 0.08 g/m; the cured layer of the first insulation layer 42 has a weight of 0.4 g/m; that of the electro-luminescent layer 44, 0.13 g/m and that of the transparent encapsulant layer 46, 0.21 g/m. The complete yarn, without the conductive strip or wire 48, therefore has a weight per unit length of 0.48 grams per meter. Although after curing the flexibility of the yarn is reduced, it is still capable of being knitted on conventional knitting machines.

It will be appreciated that a yarn of the kind shown in FIG. 7 can be used without the outer electrode strip shown in FIG. 6, and in combination with another similar yarn of which the conductive core forms the other electrode. When used together, and in contact with one another along their length, the layer 44 will luminesce upon application of an alternating current/voltage to the respective cores. It will also be understood that the electro-luminescent material may be used in place of the dielectric paste, although the protective layer 46 will normally be needed.

The electro-luminescence of a yarn of the kind illustrated in FIGS. 6 and 7 can be analyzed by the parameters of luminance and illuminance. The luminance can be derived based on the structural properties, electrical properties of the yarn and from the properties of the applied power. The measurement system to detect the luminescence of the yarn detects the parameter illuminance which is proportional to luminance (A E F Taylor, Illumination Fundamentals 2000, California, USA: Optical Research Associates). Therefore these two parameters can be used to study the luminescence of the yarns.

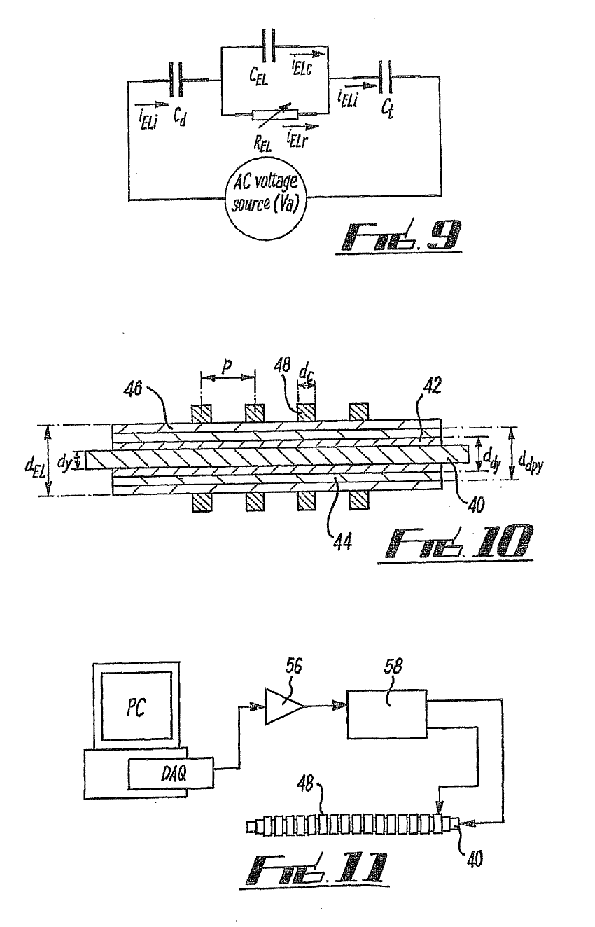

Both the dielectric (42) and transparent Insulation (46) layers of the yarn act as capacitors, with capacitances per unit area of C_{d} and C_{f} respectively. When the applied AC voltage (which is a square wave form) is increased from 0 volts the phosphor coating acts as a leaky capacitor beyond a certain threshold voltage (Vₜₕ) which can be best described as a capacitor in parallel with a non linear resistor of resistance R_{EL}. This phenomenon can be depicted as the electrical circuit shown in FIG. 9 based on the corresponding electrical circuit derived by Y. A. Ono for thin film AC electroluminescent devices [Y. A. Ono, Electroluminescent Displays, ed. H. L. Ong, Vol. 1, 1996 Singapore: World Scientific Publishing Company Limited].

The luminance (L) of the yarn can be described from the derivation given by Ono for thin film AC EI devices as,

$$L = \frac{4}{π} η \cdot {C}_{it} \cdot ( {V}_{a} - {V}_{th} ) \cdot f \cdot {E}_{ELth}$$

where,

L: luminance in cd/m²,

η: luminance efficiency, assumed as 2.5 lm/w,

Vₐ; Amplitude of the applied AC voltage in volts,

Vₜₕ: Amplitude of the threshold voltage at which the phosphor layer starts to act as a leaky capacitor and emit light in volts,

E_{ELth}: The threshold electric field at which the EL phosphor particles get excited and emit light, which is 1.5 Mvolts/cm [16]

Cᵢₜ: the series capacitance of the capacitances of the transparent layer (Cₜ) and the dielectric layer (C_{d}) in F/m².

The inner conductive yarn of the yarn is assumed to be a cylinder and the coating layers around it are considered as concentric cylinders. Moreover, the copper wire wrapped as a helix about the yarn can be assumed as composed of circular loops separated by the pitch (p) of the helix, considering the methodology used in analyzing the radiation field of helical antennas [C A Balanis, Antenna Theory; Analysis and Design, 3d. ed. 2005 Hoboken, N.J.: Wiley-Interscience]. The cross section of the copper wire is assumed to be a rectangle with its side in contact with the coating equal to its actual diameter (d_{c}). Thus the yarn can be depicted as in FIG. 10 based on these assumptions.

The capacitances of the dielectric layer (C_{d}) can be given as follows, upon considering the concentric cylinder of the dielectric layer and the inner conductive yarn [W J Duffin, Electricity and Magnetism. 2001, East Yorkshire: W J Duffin Publishing].

$${C}_{d} = \frac{2 π {ɛ}_{o} {ɛ}_{d} {d}_{c} n}{{log}_{e} ( \frac{{d}_{dy}}{{d}_{y}} )}$$

where n is the number of turns of the copper loops per meter, ∈ₒ the permittivity of free space is 8.85419×10⁻¹² F/m, and E_{d} is the relative permittivity of the dielectric paste. This can be expressed in terms of the coating thickness of the dielectric (t_{dle}) layer as,

$${C}_{d} = \frac{2 π {ɛ}_{o} {ɛ}_{d} {d}_{c} n}{{log}_{e} ( \frac{{d}_{y} + 2 {t}_{die}}{{d}_{y}} )}$$

Similarly, by considering the concentric cylinders of the complete yarn the capacitance of the transparent layer can be expressed in terms of the thickness of the transparent encapsulation (t_{enc}), phosphor (tₚ) and dielectric (t_{dle}) layers as

$${C}_{t} = \frac{2 π {ɛ}_{o} {ɛ}_{enc} {d}_{c} n}{{log}_{e} [ 1 + \frac{2 {t}_{enc}}{{d}_{y} + 2 ( {t}_{die} + {t}_{p} )} ]}$$

The series capacitance (Cᵢₜ) of the dielectric and transparent encapsulation layers can be given as,

$${C}_{it} = \frac{{C}_{t} {C}_{d}}{{C}_{t} + {C}_{d}}$$

The above equations can be consolidated to provide a result given by:

$$L = \frac{8 {d}_{p} \cdot {ɛ}_{d} \cdot {ɛ}_{t} η ( {V}_{a} - {V}_{th} ) {E}_{th} \cdot f}{( {ɛ}_{t} {log}_{e} ( 1 + \frac{2 {t}_{die}}{{d}_{y}} ) + {ɛ}_{d} {log}_{e} ( \frac{{d}_{y} + 2 ( {t}_{die} + {t}_{p} + {t}_{enc} )}{{d}_{y} + 2 ( {t}_{die} + {t}_{p} )} ) )}$$

which gives the luminance of the yarn in terms of the thickness of the dielectric, phosphor and encapsulation layers of the coating, the applied voltage and the frequency.

A yarn of the kind illustrated in FIGS. 6 and 7 can be driven from a PC controlled inverter. In the system shown in FIG. 11 the Labview software residing in the PC generates a square waveform. The duty cycle, frequency and amplitude can be changed to any value as required in the software. This signal is output via an analogue output port of the M6259 multifunction Data Acquisition board (DAQ) to a 50 W audio amplifier 56. The amplifier amplifies the signal to 11 Vrms. This amplified signal is then fed to the secondary winding of a 230V/12V step down transformer 58, which amplifies it to 300 Vrms. This voltage can be varied by changing the amplitude of the analogue output, as generated by the software. The two output leads from the primary winding of the transformer are connected to the yarn with one lead connected to the inner conductive yarn of the coated yarn and the other to the copper strand wound around it. With this system it is possible to drive the yarn with the desired AC voltage frequency and duty cycle,

Different color and intensity effects can be created by introducing color pigments and varying the density of particles in the luminescent material used. Color pigments can be introduced during manufacture of the material itself. The particle density can also be controlled at this stage. However, when the luminescent particles are encapsulated within the body of yarns when a fabric is produced, or coated on individual yarns, then of course the number of yarns used, and whether used alone or in combination with other yarns, is an additional factor.

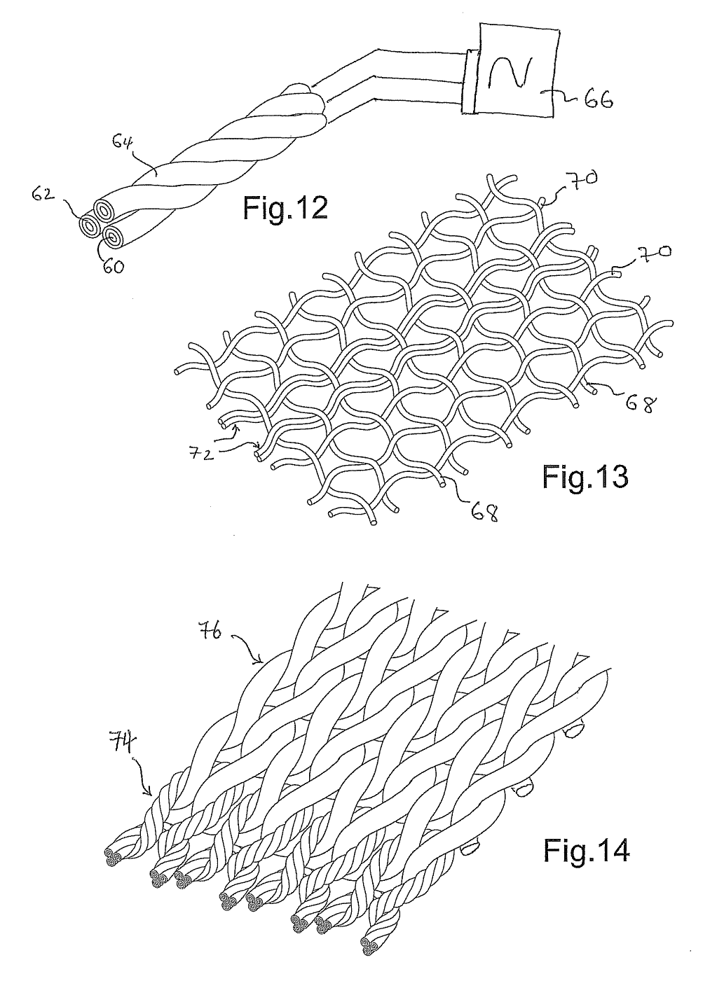

The thread of FIG. 12 consists of a plurality of yarns (three are shown) in a standard twist. Each yarn has a core 60 on which is coated a luminescent material 62, with a transparent protective layer 64. In use the cores are connected to an AC electrical supply 66, which, with three yarns in the thread, can conveniently be a three phase supply. Connection of the supply generates electric fields between the cores, provoking the material of the coating 62 to luminesce. The outside diameter of the thread of FIG. 12 is such that the thread can be used in many fabric applications such as knitting, weaving, braiding, and embroidery. The coating 62 and protective layer 64 are sufficiently thin not to adversely affect the overall flexibility of the thread. However, the protective layer can be omitted to reduce the respective diameters, providing its omission is acceptable in other respects. While three yarns are shown forming the thread, it will be appreciated that two or other numbers of yarns may be used provided connection to the AC supply generates the necessary electric field or fields.

FIG. 13 illustrates a section of woven fabric. This is of standard construction with warp and weft threads 68 and 70 but that two of the warp threads are replaced by multiple yarns 72. Each of these multiple yarns could be a twist thread of the kind shown in FIG. 12, but as shown consist merely of a plurality (two) of yarns, each having the same components as those of the thread in FIG. 12, with or without the protective layer 64. Although the multiple yarns 72 are shown adjacent in the fabric, they can of course be widely spaced. By connecting the core in each yarn of the multiple yarn to a source of alternating current, electric fields will be created between the cores, causing luminescence of the luminescent material.

FIG. 14 shows a section of knitted fabric in which two courses of multiple yarn threads 74 are incorporated in a knitted structure comprising other thread types. The structure shown is tightly knitted, with adjacent loops in each course being in contact. In this structure then, when the conductive cores of the multiple yarns are connected to an AC supply, different electric fields will be generated between adjacent cores to provoke luminescence in the luminescent material. The tight knitting pattern of FIG. 14 can be created by using elastomeric yarns 76 in combination with the multiple yarns. The elastomeric yarns will be slightly stretched during knitting, and their subsequent contraction will bring the stitched loops into engagement.

The embodiments described above have focused particularly on knitted fabrics, but the invention is also applicable to other structures including woven, braided, stitch-bonded and other non-woven structures. The precise form of the electrodes and conductive pathways will of course depend upon the nature of the basic structure.

1. A plurality of yarns each having an electrically conductive core with a layer of electro-luminescent material coated thereover, which plurality of yarns are in contact with one another; and means for connecting the yarn cores to a source of alternating electric current, whereby application of said current generates an electric field between the cores and provokes luminescence of the luminescent material.

2. A plurality of yarns according to claim 1 wherein the electro-luminescent material comprises encapsulated phosphor.

3. A plurality of yarns according to claim 1 wherein each yarn includes a protective layer over the electro-luminescent material.

4. A plurality of yarns according to claim 3 wherein the protective layer is polymeric.

5. A plurality of yarns according to claim 3 wherein the protective layer is baked on.

6. A plurality of yarns according to claim 5 wherein the protective layer is baked on by exposure to Ultra-Violet light.

7. A plurality of yarns according to claim 1 wherein the electro-luminescent material is baked on to each conductive core.

8. A plurality of yarns according to claim 1 including a layer of insulating material between each conductive core and the layer of electro-luminescent material.

9. A plurality of yarns according to claim 1 wherein each yarn core is a single length of monofilament.

10. A fabric comprising a plurality of yarns according to claim 1, which plurality of yarns are in contact with one another in accordance with a predetermined pattern.

11. A fabric structure comprising a plurality of yarns according to claim 1, which structure is one of knitted, woven, braided and embroidered.

12. A plurality of yarns for use in fabrics, wherein each yarn has a core comprising multiple conductive filaments and a layer of electro-luminescent material thereon, adjacent yarns being in physical contact, and including means for connecting the yarn cores to a source of alternating electric current, whereby application of said current generates an electric field between the cores and provokes luminescence of the luminescent material.

13. A plurality of yarns according to claim 12 wherein the filaments of each core are bound together by a dielectric paste.

14. A thread comprising a plurality of yarns twisted along the thread axis, each yarn having a conductive core with a layer of electro-luminescent material coated thereover.

15. A luminescent thread comprising a plurality of yarns twisted along the thread axis, each yarn having a conductive core with a layer of electro-luminescent material coated thereover.

16. A fabric including threads according to claim 15.

17. A fabric in which a plurality of yarns each having an electrically conductive core with a layer of electro-luminescent material coated thereover follow a common path in the fabric while in contact with each other along said path; and including means for connecting the yarn cores to a source of alternating electric current, whereby application of said current generates an electric field between the cores and provokes luminescence of the luminescent material.

18. An assembly comprising an electrically conductive layer with a fabric structure thereon, which structure has a plurality of yarns each having an electrically conductive core with a layer of electro-luminescent material coated thereover, which plurality of yarns are in contact with one another; and means for connecting the conductive layer and the yarn cores to a source of alternating electric current, whereby application of said current generates electric fields between the layer and the yarn cores and provokes luminescence of the luminescent material.

19. An assembly according to claim 18 wherein the fabric structure is one of knitted, woven, braided and embroidered.

20. An assembly according to claim 18 wherein the conductive layer is metallic.
